(19) United States
(12) Patent Application Publication
(10) Pub. No.: US 2010/0332575 A1
(43) Pub. Date: Dec. 30, 2010

(54) High-Speed Random Number Generator

(76) Inventors: Ido Kanter, Rehovot (IL); Michael Rosenbluh, Neve Tzuf (IL); Igor Reidler, Givataim (IL); Yaara Aviad, Kiryat Netafim (IL)

Correspondence Address: The Law Office of Michael E. Kondoudis, 888 16th Street, N.W., Suite 800, Washington, DC, 20006, US

(21) Appl. No.: 12/825,626

(22) Filed: Jun. 29, 2010

Related U.S. Application Data
(60) Provisional application No. 61/213,644, filed on Jun. 29, 2009.

(51) Int. Cl. G06F 7/58

(52) U.S. Cl. 708/255

(57) ABSTRACT

A method of generating a sequence of random bits is disclosed. The method comprises steps of (a) generating a stream of photons using a laser; (b) attenuating said series of photons; (c) reflecting at least a part of said stream of photons from a reflector positioned such that at least part of said stream of photons is directed from said reflector into the cavity of said laser; (d) directing a part of said stream of photons to a detector such that a signal proportional to the intensity of the radiation falling on said detector is produced; (e) sampling the AC component of said signal at a plurality of times, thereby obtaining a sampled signal comprising a sequence of data points; (f) obtaining the n^{th} time derivative of said sampled signal over at least a portion of said sample signal; and (g) adding the m least significant bits (LSBs) of said n^{th} time derivative to said sequence. By this method, truly random sequences of bits can be obtained at rates of up to at least 300 GBits/s.

### REFERENCE TO RELATED APPLICATIONS

This application claims priority from U.S. Provisional Application. No. 61/213,644, filed 29 Jun. 2009, and which is incorporated by reference in its entirety.

### FIELD OF THE INVENTION

This invention relates in general to methods and apparatus for rapid generation of a stream of truly random bits. In particular, the invention relates to methods that are based on stochastic noise generated during the operation of a laser.

### BACKGROUND OF THE INVENTION

Random number generators (RNGs) are used in many types of applications, from secure communications and cryptography to Monte Carlo simulations and stochastic modeling. For many of these applications, the speed at which the random numbers can be generated as well as the quality of the generated (as measured by, for example, its security against an attacker who is trying to guess the next number in the stream) are of paramount importance.

Many “RNG” applications are actually pseudo-RNGs. A typical pseudo-RNG is based on an algorithm that produces a sequence in which all subsequences are generated with equal probability. Such pseudo-RNGs can be random in the sense that knowledge of the current sequence does not reveal any knowledge of the next bit, and that each subsequent bit has an equal probability of being either 0 or 1. Pseudo-RNGs cannot be truly “unpredictable,” since the bit stream is completely determined by the algorithm used and the initial conditions. The main advantage of pseudo-RNGs is their low cost and the rapidity with which they can generate a stream of numbers, which is limited only by the speed of the processing hardware that produces the stream. The main disadvantage is their being completely deterministic.

Non-deterministic RNGs rely on stochastic physical processes such as the number of radioactive decays per unit time of a radioactive substance, or based on quantum phenomena such as photon arrival time, direction, or polarization (T. Jennewein et al., Rev. Sci. Instrum., 2000, 71, 1675). The primary disadvantage of these methods is their limited bandwidth. Other methods are based on thermal fluctuations in devices such as resistors or diodes. Examples of devices based on this principle are disclosed in, for example, U.S. Pat. Nos. 6,061,702, 6,195,669, and 6542014. While the bandwidth of devices of this type is limited only by the amplifier, they suffer from the drawback of extreme sensitivity to control parameters such as the threshold value and amplifier gain, which can lead to bias (deviations from true randomness) in the sequence.

Recently, RNGs have been developed where the stochastic physical process is based on the action of a laser. For example, Chinese Pat. No. 1396518 and PCT Appl. No. PCT/CN2006/001361 disclose examples of RNGs where the output of a laser is attenuated and sent through a beamsplitter to a pair of single-photon detectors. The bit is then defined by which of the two detectors is reached by a particular photon. A similar concept is used in the device disclosed in U.S. Pat. No. 6,249,009, in which a single detector is used; the value of the bit is assigned (after elimination of bias) in proportion to the number of photons that reach the detector per unit time. The inventors teach a maximum bit rate of 100 Mbits/s for this device. U.S. Pat. No. 7,284,024 discloses an RNG that splits the output of a laser into two beams, directs each beam to a detector and then measures the difference in signals reaching the two detectors.

Uchida and co-workers (Uchida, A. et al., Nature Photon. 2008, 2, 728) have recently demonstrated a 1.7 Gbit/s RNG based on the binary digitization of two independent chaotic semiconductor lasers. The mapping of each chaotic signal to a Boolean sequence is accomplished by sampling each laser at an incommensurate rate with the individual optical feedback delay times and subsequent comparison of each of the signal levels with a predetermined threshold voltage. The sequence is finally generated by performing an XOR function between the two Boolean sequences. A constant average laser intensity and a carefully tuned threshold voltage result in a sequence that passes the standard statistical tests for randomness.

Despite these many advances, there remains a need for methods and systems that are simple in design and construction, insensitive to perturbations and control parameters, and that are capable of producing a truly random stream of bits at a rate exceeding 10 Gbit/s.

### SUMMARY OF THE INVENTION

The invention herein disclosed is designed to meet this long-felt need. A single off-the-shelf laser is used to provide the stochastic signal that serves as the basis for the RNG herein disclosed. Feedback from an external cavity ensures that the laser operates in the LFF or coherence collapse regime and that the laser's behavior is chaotic. The laser output is sampled and digitized, with the m least significant bits either of the digitized value or of the nth derivative of the sequence of digitizes values (e.g., for n=1, the m bits are taken from the difference between two successive digitized values) serving as the next m bits of the random sequence. For embodiments in which the least significant bits of the value itself are used, m is in general less than 3; the methods by which the maximum useful value of m is obtained in cases in which higher derivatives are used are described in detail below.

It is therefore an object of this invention to disclose a method of generating a sequence of random bits, said method comprising steps of (a) generating a chaotic signal by a stochastic physical process; (b) sampling the AC component of said chaotic signal at a plurality of times, thereby obtaining a sampled signal comprising a sequence of data points; (c) obtaining the n^{th} time derivative of said sampled signal over at least a portion of said sample signal, where n≧0; and (d) adding the m least significant bits (LSBs) of said n^{th} time derivative to said sequence of random bits, where m≧1. It is within the essence of the invention wherein said sequence of random bits is obtained m times faster than the rate at which said step of sampling the AC component of said stochastic time-varying signal is performed.

It is a further object of this invention to disclose such a method, wherein said step (a) of generating a chaotic signal is obtained by a stochastic physical process.

It is a further object of this invention to disclose such a method, wherein said step of generating a chaotic signal further comprises additional steps of (a) generating a stream of photons using a laser; (b) creating chaotic behavior in said laser; and (c) directing a part of said stream of photons to a detector such that a signal proportional to the intensity of the radiation falling on said detector is produced, whereby said signal is chaotic.

It is a further object of this invention to disclose such a method, wherein said step of creating chaotic behavior in said laser further comprises an additional step of reflecting at least a part of said stream of photons from a reflector positioned such that at least part of said stream of photons is directed from said reflector into the cavity of said laser.

It is a further object of this invention to disclose such a method, wherein said step of creating chaotic behavior in said laser further comprises at least one additional step chosen from the group consisting of (a) providing feedback to the driving current, (b) providing feedback to an interferometer, (c) injecting photons into the cavity of said laser from another laser, and (d) any combination of the above.

It is a further object of this invention to disclose such a method, wherein said step of generating a stream of photons using a laser further comprises an additional step of generating a stream of photons using a semiconductor laser.

It is a further object of this invention to disclose such a method, further including an additional step of attenuating said stream of photons.

It is a further object of this invention to disclose such a method, wherein said step of attenuating said stream of photons further includes a step of passing said stream of photons through a neutral density filter.

It is a further object of this invention to disclose such a method, wherein said step of directing a part of said stream of photons to a detector further includes a step of passing said stream of photons through a beamsplitter positioned so as to direct a part of said stream of photons to said detector.

It is a further object of this invention to disclose such a method, wherein said steps of reflecting at least a part of said stream of photons from a reflector positioned such that at least part of said stream of photons is directed from said reflector into the cavity of said laser and of directing a part of said stream of photons to a detector are effected by use of a beamsplitter in physical communication with the housing of said laser, said beamsplitter oriented so as to reflect at least part of said beam of photons back into said cavity of said laser and to direct at least part of said beam of photons to said detector.

It is a further object of this invention to disclose such a method as defined in any of the above, wherein said step of sampling the AC component of said time-varying signal further comprises additional steps of (a) digitizing said signal at a predetermined digitization rate and with a digital resolution of k bits; and (b) sampling said digitized signal at a rate slower than said digitization rate.

It is a further object of this invention to disclose such a method as defined in any of the above, wherein n=0 and m<or equals to 3.

It is a further object of this invention to disclose such a method as defined in any of the above, wherein n=1 and m<k.

It is a further object of this invention to disclose such a method as defined in any of the above, wherein n>1 and m<k+n.

It is a further object of this invention to disclose such a method, wherein said step of reflecting at least a part of said stream of photons from reflecting means further includes an additional step of positioning said reflecting means such that the round-trip travel time for said stream of photons is incommensurate with said predetermined digitization rate, and further wherein said step of sampling the AC component of said signal further comprises additional steps of (a) digitizing said signal at a predetermined digitization rate and with a digital resolution of k bits and (b) sampling said digitized signal at a rate slower than said digitization rate; and further wherein n=1 and m<k.

It is a further object of this invention to disclose such a method as defined in any of the above, wherein said sequence of random bits passes, to a predetermined level of statistical significance, statistical tests for randomness according at least one protocol chosen from (a) NIST Special Publication 800-22 and (b) the Diehard tests.

It is a further object of this invention to disclose an apparatus for generating a sequence of random bits, said apparatus comprising (a) means for creating a chaotic signal; (b) sampling means adapted for sampling at least part the AC component of said time-varying signal, thereby producing a sampled signal; (c) derivitizing means adapted for calculating the n^{th} derivative of said sampled signal at each point, where n≧0; and (d) transmitting means adapted for transmitting the m LSBs of said n^{th} derivative. It is within the essence of the invention wherein said sequence of random bits is generated at a rate m times the sampling rate.

It is a further object of this invention to disclose such an apparatus, further including digitizing means for digitizing said chaotic signal at a predetermined rate and with digital resolution of k bits.

It is a further object of this invention to disclose such an apparatus, wherein said digitizing means comprise a digital oscilloscope.

It is a further object of this invention to disclose such an apparatus, wherein said derivitizing means comprises a digital computing apparatus with a memory comprising at least n buffers and software adapted to calculate the n^{th} derivative of said sampled signal.

It is a further object of this invention to disclose such an apparatus, further comprising (a) receiving means adapted for receiving said m LSBs from said transmitting means; and (b) storage means adapted for storing said m LSBs of said n^{th} derivative.

It is a further object of this invention to disclose such an apparatus, wherein said means for creating a chaotic signal is obtained by a stochastic physical process.

It is a further object of this invention to disclose such an apparatus, wherein said means for creating a chaotic signal comprises (a) a laser; (b) means for creating chaotic behavior in said laser; (c) a photodetector adapted to produce an output signal proportional to the intensity of the light impinging on said photodetector; and (d) directing means for directing a part of said beam of photons to said photodetector, whereby said output signal is chaotic.

It is a further object of this invention to disclose such an apparatus, wherein said means for creating chaotic behavior comprise reflecting means positioned in the stream of photons emitted by said laser so as to reflect at least part of said beam of photons back into the cavity of said laser.

It is a further object of this invention to disclose such an apparatus, wherein said reflecting means is disposed such that the round-trip time of said beam of photons is incommensurate with the digitizing rate of said digitizing means.

It is a further object of this invention to disclose such an apparatus, wherein a single beamsplitter in physical communication with the housing of said laser comprises said reflecting means and said directing means.

It is a further object of this invention to disclose such an apparatus, wherein said means for creating chaotic behavior within said laser comprise means chosen from the group consisting of (a) means for providing feedback to the driving current; (b) means for providing feedback to an interferometer; (c) injecting photons into the cavity of said laser from another laser; and (d) any combination of the above.

It is a further object of this invention to disclose such an apparatus, further including means for attenuating said beam of photons.

It is a further object of this invention to disclose such an apparatus, wherein said attenuating means comprise a neutral density filter.

It is a further object of this invention to disclose such an apparatus, wherein said directing means comprise a beamsplitter placed within said beam of photons and oriented so as to direct a fraction of said beam of photons to said photodetector.

### BRIEF DESCRIPTION OF THE FIGURES

The preferred embodiments of the invention will now be discussed with reference to the figures, wherein:

FIG. 1 is a schematic diagram of the laser implementation used to provide the random stream of bits according to one embodiment of the invention;

FIG. 2 shows a typical measurement of the AC component of the chaotic laser signal and production of a sequence of random bits therefrom according to one embodiment of the invention;

FIG. 3 shows histograms of the laser intensity and of the time derivative of the laser intensity;

FIG. 4 shows histograms of the probability of obtaining a particular value of the time derivative of the laser intensity as a function of the time derivative of the laser intensity for different signal sampling rates;

FIG. 5 is a schematic diagram of the implementation used to provide the random stream of bits according to another embodiment of the invention;

FIG. 6 shows a typical measurement of the AC component of the chaotic laser signal and production of a sequence of random bits therefrom according to the embodiment of the invention given in FIG. 5;

FIG. 7 shows probability histograms for higher time derivatives of the laser intensity;

FIG. 8 shows statistical bias in the random sequence; and,

FIG. 9 shows the autocorrelation of the laser signal and the random bit sequence for a bit sequence obtained from the first derivative of the laser intensity.

### DETAILED DESCRIPTION OF THE PREFERRED EMBODIMENTS

The present invention is described hereinafter with reference to the drawings and examples, in which preferred embodiments are described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figures and described in the specification, but only as indicated in the accompanying claims, with the proper scope determined only by the broadest interpretation of said claims.

As used herein, with reference to digitized data or the collection of digitized data, the term “derivative” refers to a discrete derivative. As a non-limiting example, for two data points with values P₁ and P₂, collected at a relative time delay of Δₜ, the first time derivative would be (P₁−P₂)/Δₜ. The nth derivative is calculated from n+1 points, e.g. the second derivative at P₁ would be [(P₃−P₂)/Δₜ−(P₂−P₁)/Δₜ]/2Δₜ, and so on. The signal itself at a specific point in time (without division by Δₜ) is considered to constitute the special case of n=0. In cases where a series of points P₁, P₂, . . . Pₙ are collected with a constant time delay Δₜ, Δₜ may be normalized to 1 without loss of generality.

As used herein, the term “sampling rate” refers to the rate at which the values of the data points that are used to generate the series of random bits are collected.

The first stage in the creation of a stream of random bits according to the present invention is the creation of a rapidly changing chaotic signal. Any source of a chaotic signal such as random electronic noise derived from an electronic device, measurements of a stochastic physical process such as radioactive decay, etc., may be used as the source of a chaotic signal. Means and methods for producing chaotic signals from such sources are well-known in the art. In preferred embodiments of the present invention, a laser (most preferably a continuous-wave semiconductor laser) is used to produce the chaotic signal. The advantages of laser-based systems are their low cost, small size, ease of use, and the high rate at which the value of the chaotic signal changes. It is these embodiments that are described in detail below.

It is a further object of this invention to disclose such an apparatus, wherein said means for creating a chaotic signal is obtained by a stochastic physical process.

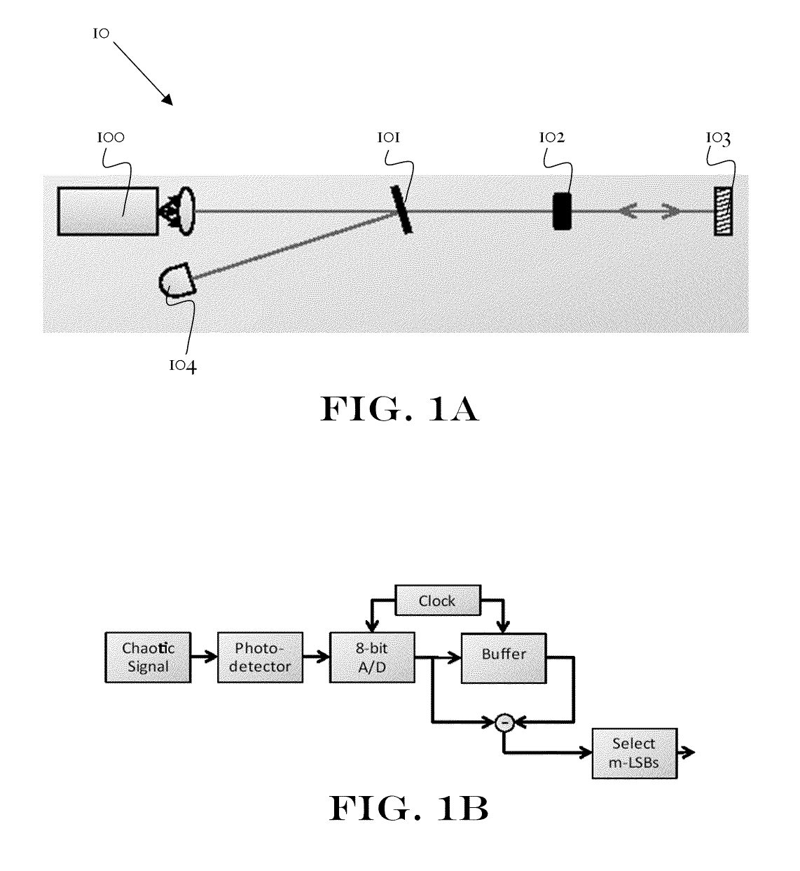

Reference is now made to FIG. 1, which provides a schematic diagram of one embodiment of an apparatus used to generate a stream of random bits. A typical setup is shown in FIG. 1A. The output of laser 100 impinges on reflecting means 103, which return at least part of the stream of photons to the laser cavity in order to ensure chaotic behavior of the laser. In preferred embodiments, the laser is a continuous-wave semiconductor laser. It is acknowledged in this respect that the output wavelength of the laser is irrelevant to the operation of the method and apparatus herein disclosed. Any wavelength convenient to the operator may be used. Reflecting means 103 may be any type of mirror or reflector appropriate to the wavelength and intensity of the light emitted from the laser and appropriate to the fraction of the light emitted from the laser that the operator desires to return into the laser cavity, including, as a non-limiting example, partial reflectors incorporated into a fiber coupled to the laser. Part of the beam of photons is directed to a high-speed photodetector (104). In embodiments in which the intensity of the laser is too high for convenience, the beam of photons passes through an attenuator (e.g., a neutral density filter) (102). In preferred embodiments, as illustrated in FIG. 1A, the beam passes through a beamsplitter (101) such that a fraction of the beam is directed to the photodetector. In other embodiments (not shown in FIG. 1), reflecting means 103 may itself comprise a beamsplitter or partially reflecting mirror that returns part of the beam of photons to the laser cavity and transmits part of the beam of photons to the photodetector. In other preferred embodiments (not shown in FIG. 1), rather than an external reflector and beamsplitter, an integrated unit is used in which a beamsplitter is placed in physical communication with the body of the laser such that part of the beam is reflected back into the laser cavity and part exits from the laser cavity, where it impinges on a photodetector. In embodiments comprising such an integrated unit, the beamsplitter may be located within the body of the laser or it may be attached to the exterior of the body of the laser at the output aperture.

The AC component of the detected signal is then measured. In preferred embodiments, the AC component of the detected signal is digitized by an ADC triggered by a clock. Any appropriate digitizing hardware known in the art may be used; non-limiting examples include digital oscilloscopes and ADC cards available as add-ons for desktop or laptop computers. The clock may be internal or external to the ADC. In typical embodiments, the bias T 3 dB low frequency cutoff=10 kHz; the high-frequency bandwidth is 40 GHz; an 8-bit ADC is used; and the clock speed is 2.5 GHz. As is explained in detail below, the rate at which the stream of random bits is produced depends most strongly on the high-frequency bandwidth of the digitizing hardware. Any type or model of commercially available ADC and external clock known in the art appropriate to the application may be used. Examples of commercially available implementations include PRECISION EDGE SY58051U, available from Micrel Inc.; the VSC8479 16-bit transceiver available from Vitesse, and the 2080MX multiplexer available from Inphi. The laser is operated moderately above its threshold current, e.g. at a ratio of Iₒₚ/Iₜₕ=1.55. The optical feedback strength is typically a few percent of the output intensity, and due to the feedback, the laser behavior is chaotic. One skilled in the art will recognize that the exact values of Iₒₚ/Iₜₕ and of the optical feedback strength are not critical to the operation of the method and apparatus disclosed herein, as long as the operational parameters are chosen to produce chaotic behavior in the laser. It is acknowledged and emphasized in this respect that the invention herein disclosed does not depend on this specific method (optical feedback) to create chaotic behavior in the laser; any means known in the art may be used. Non-limiting examples of other means for making chaotic laser light include feedback to the driving current, feedback to an interferometer; injection from another laser (which has also been shown to increase the bandwidth of the chaos), a combination of any or all of these, etc.

The method herein disclosed is insensitive to variations in the laser output, and does not require tuning of the laser or determination of a decision threshold value. In a typical embodiment, the detection bandwidth, which is limited by the bias T, is about 40 GHz, which is sufficient to resolve the temporal dynamics of the laser output. The signal from the detector is then used as the basis for creating a stream of random bits, as described in detail below.

A. >10 GBit/s RNG Using First Derivatives

The first set of embodiments discussed provide RNGs with bitrates exceeding 10 GBit/s. For these embodiments, reflector 103 is placed at a distance where the photon round trip time τ is incommensurate with the external clock rate τₛ. In a typical embodiment, reflector 103 is placed so as to yield τ=12.22 ns. In this set of embodiments, the digitized signal from the detector is stored, and, in order to generate a Boolean sequence, the m least significant bits (LSBs) of the difference between two successive measurements are used as the next m bits of the sequence, where m is an integer less than the digital resolution of the ADC (e.g., for an 8-bit ADC, 1≦m<8). The difference between consecutive digital values is obtained using any appropriate hardware or software setup capable of performing logic operations at high clock rates. The rate of random number generation is thus m times the ADC clock rate, since each measurement produces m bits of data. The data collection method is shown schematically in FIG. 1B.

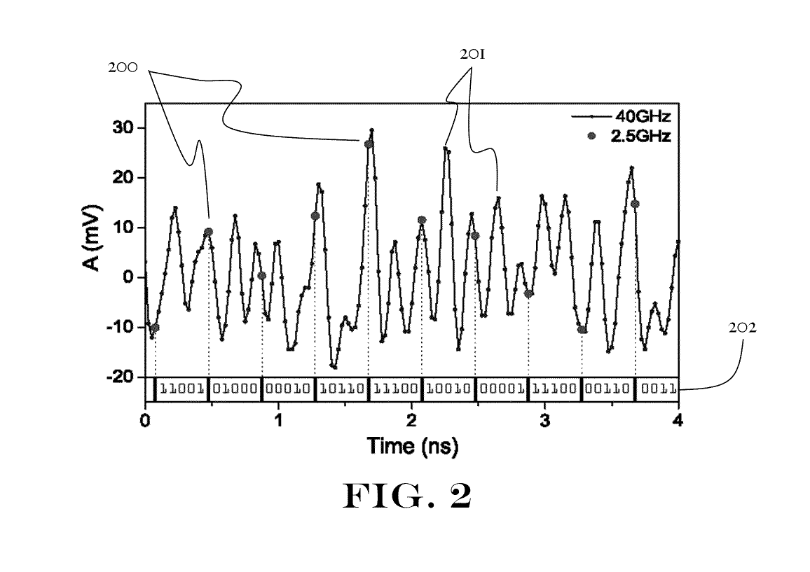

Reference is now made to FIG. 2, which shows a 4-ns trace of the digitized AC component (amplitude of the digitized detector signal as a function of time) of a typical chaotic laser signal according to one embodiment of the present invention. The figure shows data recorded at a 40 GHz digitizing rate by an 8-bit ADC. As can be seen in the figure, the 2.5 GHz sampling rate used for the RNG marked by large symbols 200 is significantly slower than the typical rate of fluctuation of the signal (the digitized signal is shown as small symbols 201, connected by a line to guide the eye). At each sampling point 200, m LSBs are obtained from the difference between the signal at the sampling point and the signal at the previous sample point and added to the random bit stream 202. In the example shown in FIG. 2, m=5, yielding an RNG rate of 12.5 GHz. As shown in the examples below, the random bit sequences thus derive pass the standard statistical tests for randomness.

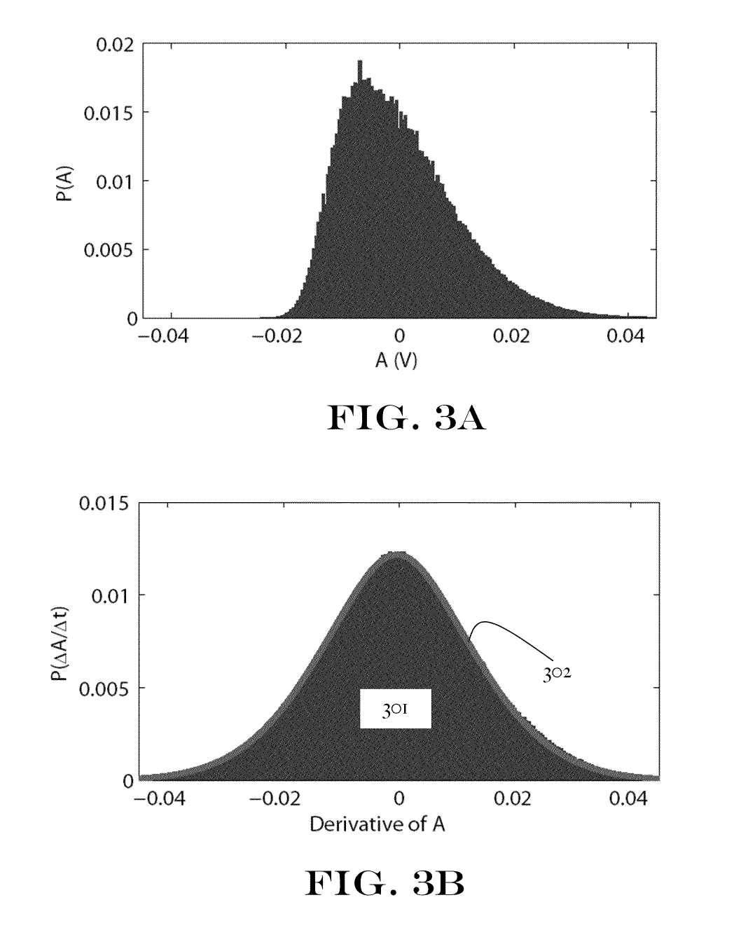

Reference is now made to FIG. 3, which shows histograms of sampled amplitudes for a 100 μs data stream. FIG. 3A shows a histogram of the distribution of the probability of obtaining a particular signal amplitude A as a function of A. For the specific signal level recorded, the number of occupied bins is 130 out of 256 available. As is typical of chaotic systems, especially for a chaotic signal comprising random spikes, the distribution is asymmetric. For an asymmetric distribution of this type, it is not possible to perform a symmetric bimodal division of the bins (i.e. define a threshold), and in general, for any finite digitization resolution, any attempt to divide the bins evenly will necessarily result in some bias. In addition, the distribution of amplitudes is not constant in time, and is expected to achieve a stationary distribution only for extremely long sampling times. For example, any change in the laser operating parameters such as the average laser power will affect the amplitude distribution. Thus, for methods that use a threshold to determine the bit value, the threshold value will be extremely sensitive to small perturbations, and will require constant tuning in order to maintain an unbiased distribution.

As explained above, rather than using the raw data, the values of time series used to generate the random numbers according to the present invention comprise successive values of the derivative Δₜ of the ADC signal amplitudes (Aₜ), where Δₜ=Aₜ−Aₜ₋₁. This approach serves substantially to eliminate the possibility of bias arising from an asymmetrical distribution of amplitudes. Reference is now made to FIG. 3B, which presents a histogram of the distribution of the probability of obtaining a particular value of Δₜ as a function of Δₜ. This plot necessarily has twice as many bins as the original distribution. As can be seen in the figure, the distribution of Δₜ is highly symmetrical. Furthermore, this distribution is unbiased, since Σᵢ₌₁^{t}Δᵢ=Aₜ−A₁, which is of the order of a typical signal amplitude, independent of the length of the sequence. One might expect that such a series is not a good candidate for a random sequence, as adjacent Δₜ values are temporally correlated even if the original amplitudes are random; for example, because of the upper bound on the amplitudes, it is unlikely to have two successive large positive values for Δₜ. In order to obviate this difficulty, the invention herein disclosed uses only the m LSBs for each Δₜ, relying on the chaotic nature of the time varying laser intensity.

As can be seen from FIG. 3B, the values of the discrete derivatives form a highly symmetric histogram centered about zero, allowing for unbiased, even distribution of the bins into even and odd bins based on the LSB of the bin. Having an unbiased distribution is a necessary, but not a sufficient, condition for a true RNG. In order to ensure randomness, the order in which the bins are filled has to be random, that is, the probability that the next value in the time series will be assigned to an even or odd bin must be independent of the even/odd value of the current bin. The distance between two adjacent amplitudes starting from a given bin value diverges, hence their subsequent probability to end up in an even or odd bin is equal provided that the sampling rate (clock period) is sufficiently slow relative to the strength of the disorder.

At the 2.5 GHz sampling rate used in a preferred embodiment of the present invention, the probability of being in an even or odd bin is independent of recent history, and, in addition, the probability of being in any bin is independent of the current bin. This independence can be demonstrated by constructing the histogram of the derivatives by two different procedures; if the probabilities are truly independent, then the form histogram should not depend on the procedure used to construct it. Histogram 301 in FIG. 3B was constructed by using the original time series of the amplitudes and counting the number of occurrences of a given value of the derivative for the entire sequence. Histogram 302 in FIG. 3B was constructed by using only the distribution of amplitudes plotted in FIG. 3A, from which all time dependence has been eliminated, using the formula P(n Δ̅)=Σ_{k,m}P(Aₖ)P(Aₘ)δ(Aₖ−Aₘ−n Δ̅), where Δ̅ is the value of the amplitude of the LSB of the 8-bit ADC and n is an integer between −255 and +255. The histograms are nearly identical, thus implying that the joint probability distribution of two successive amplitudes, <P(Aₜ=Aₖ;Aₜ₊₁=Aₘ>ₜ=P(Aₖ)P(Aₘ)v k and m, where < . . . > represents a time average, and that correlations between two successive bins are negligible.

In other embodiments of the invention, other values of m may be used. While, as explained above, in principle, m may take any value lower than the digital resolution of the ADC, the practical upper limit to m depends on the shape of the distribution of intensity derivatives. When this distribution becomes narrow, mₘₐₓ decreases, since the distribution of all mₘₐₓ-bits-tuples becomes biased.

The upper limit on the speed of the RNG disclosed herein is determined by several factors. The first limitation is the local structure of the chaotic signal, which consists of spikes and thus the derivative of the signal over a time comparable to the spike width will have regular and well-defined behavior. Furthermore, the derivative between spikes will consistently be near zero. The sample rate must therefore be slower than the spike width or the time between spikes, whichever is longer, in order to ensure that two successive recorded amplitudes are uncorrelated. A second limitation is the strength and bandwidth of the disorder in the signal. Hence, the sampling rate has to be slower than the typical time periods where the system is non-chaotic.

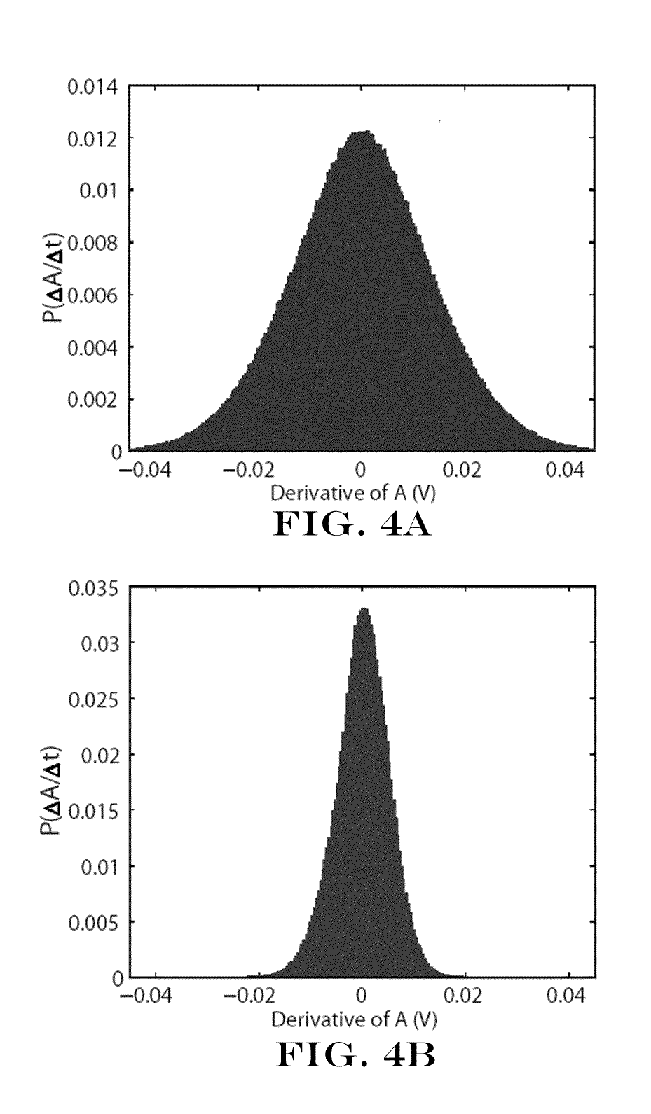

In alternative embodiments of the invention, the same RNG rate is obtained by using a slower ADC with a higher resolution. Reference is now made to FIG. 4, which shows histograms of the probability distribution of the time derivative for two different sampling rates. FIG. 4A shows a histogram for a sampling rate of 100 MHz, while FIG. 4B shows a histogram for a sampling rate of 40 GHz. The histogram in FIG. 4A is substantially identical to that shown in FIG. 3B, indicating that at the slower sampling rate, successive data points remain uncorrelated, and that at the slower sampling rate, a larger number of LSBs may be used, thus maintaining the same rate of production of random bits. As shown in FIG. 4B, if the sampling rate becomes too high relative to the digitization rate of the data, the distribution significantly narrows, indicating correlations between successive sampled intensities.

It is acknowledged in this respect that the RNG may in fact use m LSBs of the signal itself (n=0). While as shown in FIG. 3A, the probability distribution of the signal intensity is not symmetrical about zero, the probability distribution of the LSB of the signal intensity is symmetrical about zero, and hence, the signal itself may be used as the basis of the RNG in some embodiments of the invention. As is clear from FIG. 3, the number of LSBs used in these embodiments will necessarily have to be smaller than for embodiments in which the derivative is used as the basis of the RNG. In preferred embodiments in which n=0, m<or equals to 3, as it was found that for larger values of m, the bit sequence no longer passes statistical tests for randomness.

B. >100 GBit/s RNG Using Higher Derivatives

In additional embodiments of the invention herein disclosed, higher derivatives of the sampled signal are used to derive the sequence of random bits. In these embodiments, the position of the reflector is not limited to distances that guarantee a round-trip time incommensurate with the clock timing. Furthermore, these embodiments are not limited by the structure of the chaotic waveform constructed of pulses of ˜100 ps width and by rare events within the chaotic waveform. In typical embodiments, the external cavity round trip time τ is tuned to any desired value by using the periodicity of the shifted correlation function in τ.

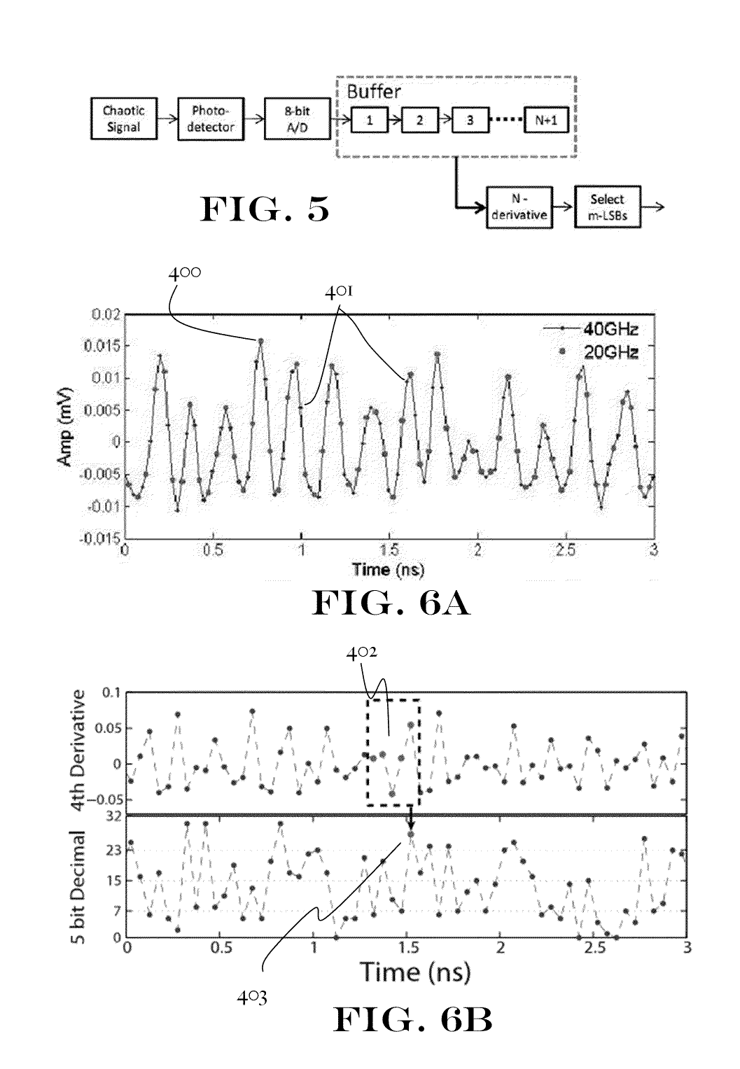

Reference is now made to FIG. 5, which provides a schematic illustration of the operation of the RNG scheme according to these embodiments. It is substantially the same as that illustrated in FIG. 1, except that in these cases, n+1 successive sampled values (n>1) are used to determine the n^{th} time derivative of the signal.

Reference is now made to FIG. 6, which shows a 3-ns trace of the digitized AC component (amplitude of the digitized detector signal as a function of time) of a typical chaotic laser signal according to one embodiment of the present invention. FIG. 6A shows data recorded at a 40 GHz digitizing rate by an 8-bit ADC. In this case, the sampling rate used for the RNG (marked by large symbols 400) is 20 GHz, while the overall digitization rate of the signal (marked by small symbols 401, connected by a line to guide the eye) is 40 GHz. At each sampling point 400, the n^{th} derivative is calculated from n+1 successive values of the digitized waveform, and the m LSBs of the n^{th} derivative are appended to the sequence of random bits. This process is illustrated in FIG. 6B for a case where n=4 and m=5 (where m is the number of LSBs used). The upper panel shows five sampled points 402 within the box marked by dotted lines, and the lower panel shows the decimal value of the m LSBs. In this case, the 20 GSample/s sampling rate with n=4 and m=5 leads to a RNG rate of 100 Gbits/s. As shown in the examples below, the random bit sequences thus generate pass the NIST Special Publication 800-22 statistical test suite using 1000 sequences of 1 Mbit length and the Diehard suite using sequences of 74 Mbit length.

The use of higher derivatives of the digitized chaotic signal increases the upper bound on the sampling rate of the RNG and the number m of LSBs used to derive the random bit sequence. If the values of the sampled points are used, the speed of the RNG is bounded from above by the local structure of the chaotic waveform. The chaotic spikes have a typical duration of ˜100 ps, limiting the speed to less than 10 GBits/s (in practices, to ˜1-2 GBits/s) in order to avoid a high probability of repeated signals. Using the first derivative of the signal as described above relaxes this constraint, since the derivative in the first half of the spike is positive, and negative in the second half. Higher derivatives of the chaotic signal amplify local changes in the temporal behavior of the chaotic signal, and allow the use of a sampling rate comparable to that of the digitization rate. In the case of the embodiments of the invention illustrated here, use of higher derivatives allows creation of a random sequence of bits at half the digitization rate (20 GHz for 40 GHz digitization). The amplification of local changes in the chaotic behavior by the use of higher derivatives also allows the user to increase the number of LSBs used at each sampling point.

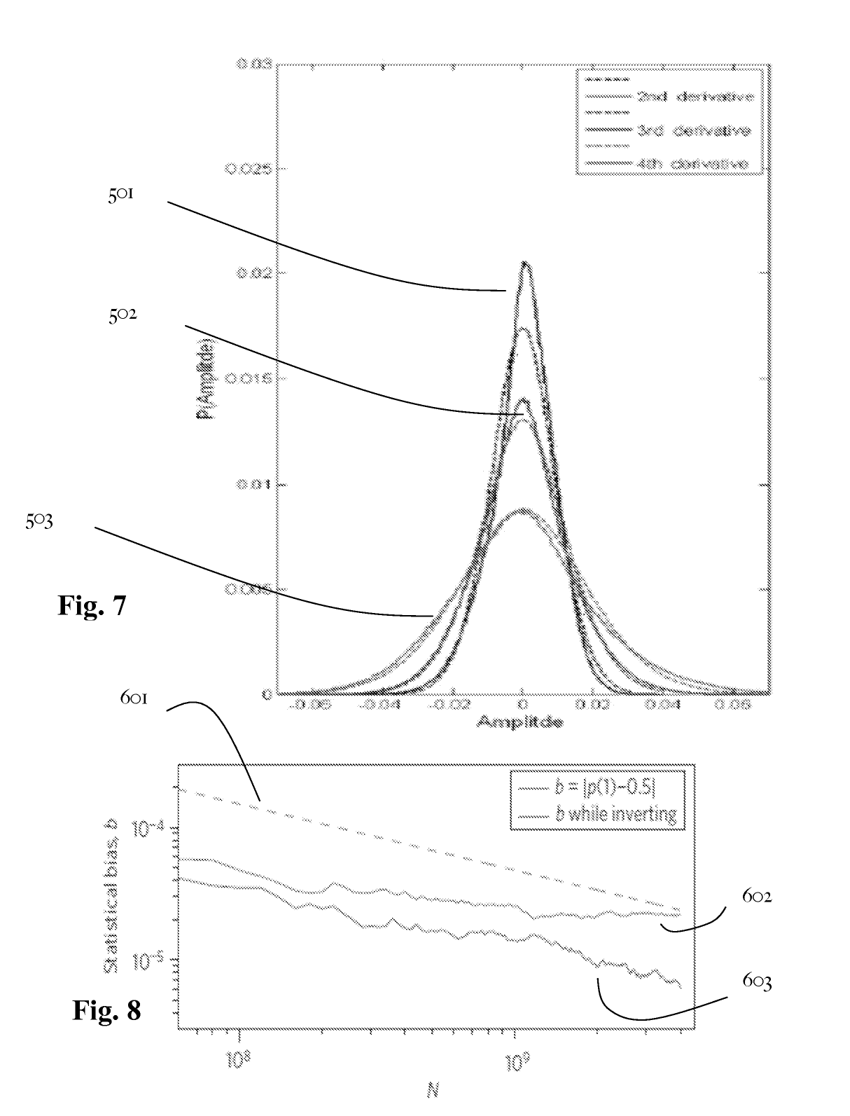

Reference is now made to FIG. 7, which shows histograms for a 8-bit RNG sequences measured over 100 μs at a 20 GHz sampling rate and calculated using the second (501), third (502), and fourth (503) derivatives. The solid lines show results for derivatives calculated from n+1 successive points, and the dashed lines show results for derivatives calculated from the histogram of the (n−1)^{th} derivative of the signal waveform. These calculations are directly analogous to those done for the first derivative results (2.5 GHz sampling rate) illustrated in FIG. 3B. As the results shown in the figure indicate, for the second and third derivatives, the two methods of calculating the derivative produce different results, implying that the necessary conditions for true randomness have not been met. In contrast, the results for the fourth derivative are independent of the method by which the derivative is calculated, indicating that for this sampling rate, at least the fourth derivative must be obtained in order to insure that the resulting sequence is truly random.

The bias in the sequence, corresponding to the deviation of the distribution from a perfectly even division of the bits into zeroes and ones, is of course expected to have statistical fluctuations, on the order of 1/\sqrt{N}, where N is the number of elements in the sequence. Indeed, for our ADC, at a sampling rate of 20 GHz, fourth derivative and 5 LSBs, the bias is below statistical fluctuations for sequences shorter than ˜4 Gbit. Reference is now made to FIG. 8, which shows graphically the statistical bias in the random sequence as a function of the sequence length N.

The statistical bias b is defined by b=|p(1)−0.5|, where p(1) is the probability of ones in the sequence. The dashed line 601 represents the statistical three standard deviation limit, 3\sqrt{N}/2. Solid line 602 gives the statistical bias in the sequence as a function of the sequence for a sequence generated from the fourth derivative at a 20 GHz sampling rate and m=5 LSBs. Solid line 603 shows is the statistical bias b when the binary representation is inverted on a timescale of 0.1 ms.

As N becomes much larger, the bias deviates from the criteria of three standard deviation, 3\sqrt{N}/2, and becomes statistically significant. This is due to the non-ideal nature of any real analog-to-digital converter, which will always have some nonlinearity, and, in particular, the bin width of the ADC (measured in volts) may vary to some extent. This phenomenon leads to a slightly different population distribution in some of the bins, even when the input is a uniformly distributed random variable. The population imbalance of the bins can thus lead to a slightly different number of ones or zeroes in the constructed binary string, resulting in a statistical bias in the sequence. As N becomes larger, this imbalance will converge to a constant percentage of the total sequence length and exceed the 3\sqrt{N}/2 standard deviation. It is possible to eliminate this instrumental bias by inverting the binary bit representation (the highest bin is mapped to 00000000 instead of 11111111 and so on) at a low non-periodic rate (˜0.1 ms). Using this technique we eliminate he bias, as shown in FIG. 8. The bias of the inverted sequence scales n proportion with 1/, removing any limitation on the overall length of the sequence.

Three interconnected parameters control the speed and hardware necessary to implement the RNG disclosed in the present invention: (1) the sampling rate; (2) the number m of LSBs used to generate the bit sequence; and (3) the order n of the n^{th} derivative of the waveform used to generate the bit sequence. As shown in the examples below, by using the 12th derivative and an 8-bit ADC, an RNG speed of 240 Gbits/s is achievable using m=12. Use of such a high value of in is possible in this case even with an 8-bit ADC because each successive derivative doubles the number of possible levels; e.g. the first derivative of an 8-bit signal has 512 possible values (9 bits), the second derivative has 1024 possible values (10 bits), and so on. As shown in FIG. 8, as the order of the derivative increases, the distribution becomes more flattened, which is a necessary condition for the use of a higher number of LSBs.

Although extremely high-speed RBGs can thus be generated, one has to keep in mind that the maximal information taken from each sampled point is at most 8 bits due to the 8-bit digitization of the original signal. The possible use of more than 8 bits per sampling point is a result of the higher derivatives introducing a redundancy in the sequence. For derivatives up to some maximum value, this redundancy does not affect the sequence randomness as tested by the statistical tests, and allows for a great increase in the speed of the RBG. The process stops working at even higher derivatives because the redundancy thus introduced leads to statistical correlations in the bit stream and they fail the statistical tests.

### Example 1

An RNG was constructed using a Lasermate Model LD-660-50A semiconductor laser (wavelength 656 nm, threshold current 42 mA), a Hamamatsu model G4176-03 photodetector (risetime 30 ps), a Picosecond model 5542 bias-tee (risetime 7 ps), and a Tektronix model TDS-6124C digital oscilloscope (Bandwidth 12 GHz, maximum sampling rate 40 GS/s). The laser was operated at a laser injection current of 65 mA and an operating temperature of 19.60° C. The reflector was placed such that the external cavity round trip time was 12.225 ns.

A bit sequence was obtained using the first derivative of the chaotic laser intensity fluctuations using m=5 LSBs at a sampling rate of 2.5 GHz, yielding a random bit generation rate of 12.5 Gbits/s. Statistical tests according to the NIST Special Publication 800-22 statistical test suite for 1000 sequences, each of 1 Mbit length, are summarized in Table 1. For these sequences, “success” at the 0.01 significance level corresponds to a P-value >0.0001 and a proportion >0.9805608. For tests that produced multiple P-values and proportions, the worst case is shown.

TABLE 1
Statistical results (NIST Special Publication
800-22) for a 12.5 GBit/s RNG

| Statistical Test | P-Value | proportion | result |
|---|---|---|---|
| Frequency | 0.383827 | 0.9900 | success |
| Block Frequency | 0.591409 | 0.9890 | success |
| Cumulative Sums | 0.593478 | 0.9940 | success |
| Runs | 0.869278 | 0.9930 | success |
| Longest run | 0.980883 | 0.9890 | success |
| Rank | 0.041709 | 0.9910 | success |
| Nonperiodic templates | 0.007694 | 0.9910 | success |
| Overlapping templates | 0.163513 | 0.9830 | success |
| Universal | 0.670396 | 0.9870 | success |
| Approximate entropy | 0.114040 | 0.9830 | success |
| Random excursions | 0.133216 | 0.9919 | success |
| Random excursions variant | 0.031213 | 0.9886 | success |
| Serial | 0.272977 | 0.9870 | success |
| Linear complexity | 0.208837 | 0.9850 | success |

Results for the Diehard series of statistical tests for a 74-Mbit long sequence of random bits produced according to this embodiment of the invention are given in Table 2 (“KS”=Kolmogorov-Smimov test). For these statistical tests, “success” indicates a significance level of >0.01.

TABLE 2
Diehard statistical test results for a 12.5 GBit/s RNG

| Statistical Test | p-value | | Result |
|---|---|---|---|
| Birthday Spacing | 0.666803 | [KS] | Success |
| Overlapping 5-permutation | 0.448533 | | Success |
| Binary rank for 31 × 31 matrices | 0.893334 | | Success |
| Binary rank for 32 × 32 matrices | 0.665553 | | Success |
| Binary rank for 6 × 8 matrices | 0.359906 | [KS] | Success |
| Bitstream | 0.011200 | | Success |
| Overlapping-Pairs-Sparce-Occupancy | 0.038600 | | Success |
| Overlapping-Quadruples-Sparce-Occupancy | 0.020800 | | Success |
| DNA | 0.012900 | | Success |
| Count-the-1's on a stream of bytes | 0.037367 | | Success |
| Count-the-1's for specific bytes | 0.093421 | | Success |
| Parking lot | 0.381128 | [KS] | Success |
| Minimum distance | 0.388601 | [KS] | Success |
| 3D spheres | 0.531692 | [KS] | Success |
| Sqeeze | 0.128150 | | Success |
| Overlapping sums | 0.246954 | [KS] | Success |
| Runs | 0.378509 | [KS] | Success |
| Craps | 0.481853 | | Success |

### Example 2

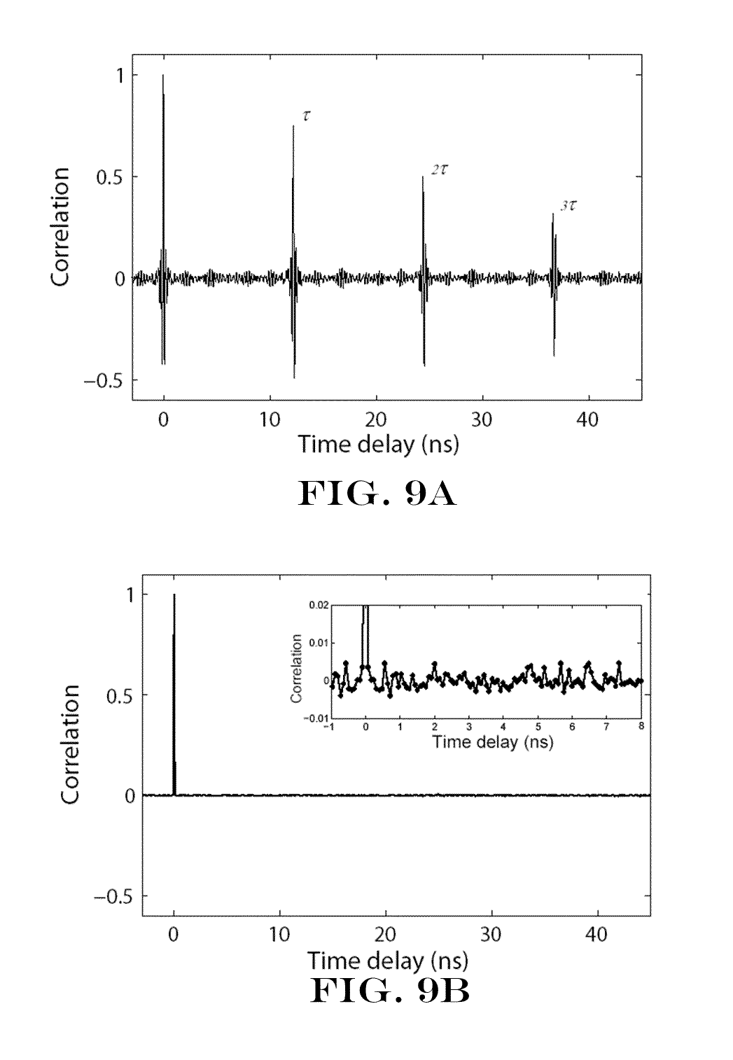

The chaotic intensity fluctuations of semiconductor lasers with external feedback exhibit periodic behavior of the chaos with a period equal to the time delay of the feedback propagation time τ. Reference is now made to FIG. 9, which shows the autocorrelation calculated for the laser intensity prior to performing the first derivative and bit extraction for a sequence of length N=50 000 data points. The correlation revives at integer multiples of τ, and slowly decreases as N increases, as shown in FIG. 9A. After performing the derivative and bit extraction, thus obtaining a bit sequence of 25 000 points, the periodicity in τ is eliminated, as shown in the random bit sequence autocorrelation calculation shown in FIG. 9B. As shown in the inset in FIG. 9B, a closer look at the autocorrelation near zero time delay shows that the correlation drops to the noise level in a time less than the time delay between two adjacent bits.

### Example 3

An RNG was constructed using a Lasermate Model LD-660-50A semiconductor laser (wavelength 656 nm, threshold current 42 mA), a Hamamatsu model G4176-03 photodetector (risetime 30 ps), a Picosecond model 5542 bias-tee (risetime 7 ps), and a Tektronix model TDS-6124C digital oscilloscope (Bandwidth 12 GHz, maximum sampling rate 40 GS/s). The laser was operated at a laser injection current of 65 mA and an operating temperature of 19.60° C. The reflector was placed such that the external cavity round trip time was 10 ns (i.e. commensurate with the clock time).

A bit sequence was obtained using the fourth derivative of the chaotic laser intensity fluctuations using m=5 LSBs at a sampling rate of 20 GHz, yielding a random bit generation rate of 100 Gbits/s. Statistical results using the NIST Special publication 800-22 statistical test suite are given in Table 3 for 1000 bit sequences, each of which was 1 Mbit in length. “Success” is defined as in example 1. For tests that produced multiple P-values and proportions, the worst case is shown. “Diehard” statistical test results are given in Table 4 for a 74 MBit-long sequence obtained by the same procedure. As can be seen from the results summarized in the tables, the bit sequences passed all statistical tests of randomness.

TABLE 3
Statistical results (NIST Special Publication
800-22) for a 100 GBit/s RNG

| Statistical test | P-value | Proportion | Result |
|---|---|---|---|
| Frequency | 0.719747 | 0.9910 | Success |
| Block frequency | 0.478839 | 0.9930 | Success |
| Cumulative sums | 0.250558 | 0.9910 | Success |
| Runs | 0.422638 | 0.9940 | Success |
| Longest run | 0.023386 | 0.9880 | Success |
| Rank | 0.889118 | 0.9890 | Success |
| FFT | 0.085068 | 0.9840 | Success |
| Nonperiodic templates | 0.002677 | 0.9910 | Success |
| Overlapping templates | 0.858002 | 0.9860 | Success |
| Universal | 0.934599 | 0.9920 | Success |
| Approximate entropy | 0.643366 | 0.9900 | Success |
| Random excursions | 0.049479 | 0.9857 | Success |
| Random excursions variant | 0.045532 | 0.9968 | Success |
| Serial | 0.068999 | 0.9870 | Success |
| Linear complexity | 0.618385 | 0.9920 | Success |

TABLE 4
Diehard statistical test results for a 100 GBit/s RNG

| Statistical Test | p-value | | Result |
|---|---|---|---|
| Birthday Spacing | 0.134473 | [KS] | Success |
| Overlapping 5-permutation | 0.087852 | | Success |
| Binary rank for 31 × 31 matrices | 0.987001 | | Success |
| Binary rank for 32 × 32 matrices | 0.698930 | | Success |
| Binary rank for 6 × 8 matrices | 0.509448 | [KS] | Success |
| Bitstream | 0.078630 | | Success |
| Overlapping-Pairs-Sparce-Occupancy | 0.061900 | | Success |
| Overlapping-Quadruples-Sparce-Occupancy | 0.031300 | | Success |
| DNA | 0.011200 | | Success |
| Count-the-1's on a stream of bytes | 0.087557 | | Success |
| Count-the-1's for specific bytes | 0.018640 | | Success |
| Parking lot | 0.760886 | [KS] | Success |
| Minimum distance | 0.131171 | [KS] | Success |
| 3D spheres | 0.222125 | [KS] | Success |
| Sqeeze | 0.583890 | | Success |
| Overlapping sums | 0.557041 | [KS] | Success |
| Runs | 0.120943 | [KS] | Success |
| Craps | 0.382210 | | Success |

### Example 4

The RNG described in Example 3 (sampling frequency 20 GHz) was used to produce a sequence of random bits using the 16th derivative and m=15 LSBs, thus yielding an effective bit production rate of 300 GBit/s. The results of statistical tests according to the NIST Special Publication 800-22 suite are given in Table 5, with “success” defined as in the previous examples. As can be seen from the results summarized in the table, the RNG passed all statistical tests for randomness.

TABLE 5
Statistical results (NIST Special Publication
800-22) for a 300 GBit/s RNG

| Statistical test | P-value | Proportion | Result |
|---|---|---|---|
| Frequency | 0.082513 | 0.9.840 | Success |
| Block frequency | 0.052275 | 0.9940 | Success |
| Cumulative sums | 0.211064 | 0.9870 | Success |
| Runs | 0.969588 | 0.9930 | Success |
| Longest run | 0.502247 | 0.9850 | Success |
| Rank | 0.821937 | 0.9880 | Success |
| Nonperiodic templates | 0.006425 | 0.9870 | Success |
| Overlapping templates | 0.798139 | 0.9910 | Success |
| Universal | 0.429923 | 0.9840 | Success |
| Approximate entropy | 0.433590 | 0.9910 | Success |
| Random excursions | 0.040888 | 0.9871 | Success |
| Random excursions variant | 0.022671 | 0.9887 | Success |
| Serial | 0.783019 | 0.9880 | Success |
| Linear complexity | 0.031219 | 0.9940 | Success |

### Example 5

As discussed above, three interconnected parameters control the speed and hardware required to implement the RNG disclosed in the present invention. A complete examination of the maximum achievable rate (i.e. traversing the entire 3D space defined by the three parameters) is a heavy numerical task, and, moreover, the results are expected to vary as a function of the details of the experimental setup. Some examples of variations in the parameters that led to RNGs that gave output that passed all statistical tests for randomness are given in Table 6.

TABLE 6
Examples of successful RNGs according to the present invention

| m | n | Sampling rate | RNG rate |
|---|---|---|---|
| (LSBs) | (order of derivative) | (GHz) | (Gbits/s) |
| 5 | 4 | 0.5 | 2.5 |
| 5 | 4 | 2.5 | 12.5 |
| 10 | 8 | 2.5 | 25 |
| 5 | 12 | 20 | 100 |
| 8 | 10 | 20 | 160 |
| 12 | 12 | 20 | 240 |
| 15 | 16 | 20 | 300 |

The results summarized in Table 6 indicate that for a fixed sampling rate of 20 GHz and m=5 LSBs, there is a window in the order of derivatives, namely 4<n<12. For higher and lower order derivatives, the resulting RNGs were not successful. For a fixed sampling rate, the number of LSBs that can be used successfully increases with the order of the derivative up to some maximum order n, as discussed above.

We claim:

1. A method of generating a sequence of random bits, said method comprising steps of:
a. generating a chaotic signal;
b. sampling the AC component of said chaotic signal at a plurality of times, thereby obtaining a sampled signal comprising a sequence of data points;
c. obtaining the n^{th} time derivative of said sampled signal over at least a portion of said sample signal, where n≧0; and,
d. adding the m least significant bits (LSBs) of said n^{th} time derivative to said sequence of random bits, where m≧1;
wherein said sequence of random bits is obtained m times faster than the rate at which said step of sampling the AC component of said stochastic time-varying signal is performed.

2. The method of claim 1, wherein said step of generating a chaotic signal further comprises additional steps of:
a. generating a stream of photons using a laser;
b. creating chaotic behavior in said laser; and,
c. directing a part of said stream of photons to a detector such that a signal proportional to the intensity of the radiation falling on said detector is produced;
whereby said signal is chaotic.

3. The method of claim 2, wherein said step of creating chaotic behavior in said laser further comprises an additional step of reflecting at least a part of said stream of photons from a reflector positioned such that at least part of said stream of photons is directed from said reflector into the cavity of said laser.

4. The method of claim 2, wherein said step of creating chaotic behavior in said laser further comprises at least one additional step chosen from the group consisting of (a) providing feedback to the driving current, (b) providing feedback to an interferometer, (c) injecting photons into the cavity of said laser from another laser, and (d) any combination of the above.

5. The method of claim 2, wherein said step of generating a stream of photons using a laser further comprises an additional step of generating a stream of photons using a semiconductor laser.

6. The method of claim 2, further including an additional step of attenuating said stream of photons.

7. The method of claim 6, wherein said step of attenuating said stream of photons further includes a step of passing said stream of photons through a neutral density filter.

8. The method of claim 2, wherein said step of directing a part of said stream of photons to a detector further includes a step of passing said stream of photons through a beamsplitter positioned so as to direct a part of said stream of photons to said detector.

9. The method of claim 3, wherein said steps of reflecting at least a part of said stream of photons from a reflector positioned such that at least part of said stream of photons is directed from said reflector into the cavity of said laser and of directing a part of said stream of photons to a detector are effected by use of a beamsplitter in physical communication with the housing of said laser, said beamsplitter oriented so as to reflect at least part of said beam of photons back into said cavity of said laser and to direct at least part of said beam of photons to said detector.

10. The method of claim 1, wherein said step of sampling the AC component of said signal further comprises additional steps of:
a. digitizing said signal at a predetermined digitization rate and with a digital resolution of k bits; and,
b. sampling said digitized signal at a rate slower than said digitization rate.

11. The method of claim 10, wherein n=0 and m<or equals to 3.

12. The method of claim 10, wherein n=1 and m<k.

13. The method of claim 10, wherein n>1 and m<k+n.

14. The method of claim 2, wherein said step of reflecting at least a part of said stream of photons from reflecting means further includes an additional step of positioning said reflecting means such that the round-trip travel time for said stream of photons is incommensurate with said predetermined digitization rate, and further wherein said step of sampling the AC component of said signal further comprises additional steps of (a) digitizing said signal at a predetermined digitization rate and with a digital resolution of k bits and (b) sampling said digitized signal at a rate slower than said digitization rate; and further wherein n=1 and m<k.

15. The method of claim 1, wherein said sequence of random bits passes, to a predetermined level of statistical significance, statistical tests for randomness according at least one protocol chosen from (a) NIST Special Publication 800-22 and (b) the Diehard tests.

16. An apparatus for generating a sequence of random bits, said apparatus comprising:
a. means for creating a chaotic signal;
b. sampling means adapted for sampling at least part the AC component of said chaotic signal to produce a sampled signal;
c. derivitizing means adapted for calculating the n^{th} derivative of said sampled signal at each point, where n>0; and,
d. transmitting means adapted for transmitting the m LSBs of said n^{th} derivative;
wherein said sequence of random bits is generated at a rate m times the sampling rate.

17. The apparatus of claim 16, further including digitizing means for digitizing said chaotic signal at a predetermined rate and with digital resolution of k bits.

18. The apparatus of claim 17, wherein said digitizing means comprise a digital oscilloscope.

19. The apparatus of claim 16, wherein said derivitizing means comprises a digital computing apparatus with a memory comprising at least n buffers and software adapted to calculate the n^{th} derivative of said sampled signal.

20. The apparatus of claim 16, further comprising:
a. receiving means adapted for receiving said m LSBs from said transmitting means; and,
b. storage means adapted for storing said m LSBs of said n^{th} derivative.

21. The apparatus of claim 16, wherein said means for creating a chaotic signal comprises:
a. a laser;
b. means for creating chaotic behavior in said laser;
c. a photodetector adapted to produce an output signal proportional to the intensity of the light impinging on said photodetector; and,
d. directing means for directing a part of said beam of photons to said photodetector;
whereby said output signal is chaotic.

22. The apparatus of claim 21, wherein said means for creating chaotic behavior comprise reflecting means positioned in the stream of photons emitted by said laser so as to reflect at least part of said beam of photons back into the cavity of said laser.

23. The apparatus of claim 22, wherein said reflecting means is disposed such that the round-trip time of said beam of photons is incommensurate with the digitizing rate of said digitizing means.

24. The apparatus of claim 21, wherein a single beamsplitter in physical communication with the housing of said laser comprises said reflecting means and said directing means.

25. The apparatus of claim 21, wherein said means for creating chaotic behavior within said laser comprise means chosen from the group consisting of (a) means for providing feedback to the driving current; (b) means for providing feedback to an interferometer; (c) injecting photons into the cavity of said laser from another laser; and (d) any combination of the above.

26. The apparatus of claim 21, further including means for attenuating said beam of photons.

27. The apparatus of claim 26, wherein said attenuating means comprise a neutral density filter.

28. The apparatus of claim 21, wherein said directing means comprise a beamsplitter placed within said beam of photons and oriented so as to direct a fraction of said beam of photons to said photodetector.

29. The apparatus of claim 16, wherein said means for creating a chaotic signal is obtained by a stochastic physical process.
